(19) United States
(12) Patent Application Publication
(10) Pub. No.: US 2019/0312524 A1
(43) Pub. Date: Oct. 10, 2019

(54) CONVERTER

(71) Applicant: Huawei Technologies Co., Ltd., Shenzhen (CN)

(72) Inventors: Zhuyong HUANG, Dongguan (CN); Xiaofei ZHANG, Dongguan (CN)

(21) Appl. No.: 16/450,360

(22) Filed: Jun. 24, 2019

Related U.S. Application Data
(63) Continuation of application No. PCT/CN2017/095758, filed on Aug. 3, 2017.

(30) Foreign Application Priority Data
Dec. 23, 2016 (CN) 201611207766.2

(51) Int. Cl. H02M 7/483; H02M 7/5387; H02M 7/797; H02M 1/08

(52) U.S. Cl. CPC H02M 7/483; H02M 7/53871; H02M 2001/0048; H02M 1/08; H02M 7/797

(57) ABSTRACT

A converter, configured to be connected between a direct current system and an alternating current system for mutual conversion between a direct current and an alternating current, includes a switching network, a filter, and a control unit. The switching network includes a first switching circuit and a second switching circuit. The first switching circuit includes M energy storage elements and M bridge arm circuits, one of the M bridge arm circuits includes one full-controlled component, and remaining M-1 bridge arm circuits each include two full-controlled components that are reversely connected in series. The second switching circuit includes N energy storage elements and N bridge arm circuits, one of the N bridge arm circuits includes one full-controlled component, and remaining N-1 bridge arm circuits each include two full-controlled components that are reversely connected in series.

### CROSS-REFERENCE TO RELATED APPLICATIONS

This application is a continuation of International Application No. PCT/CN2017/095758, filed on Aug. 3, 2017, which claims priority to Chinese Patent Application No. 201611207766.2, filed on Dec. 23, 2016. The disclosures of the aforementioned applications are hereby incorporated by reference in their entireties.

### TECHNICAL FIELD

Embodiments of this application relate to the energy power supply field, and more specifically, to a converter.

### BACKGROUND

Development of the economic society is accompanied with gradual prominence of an energy crisis and gradual deterioration of the global environment. Therefore, developing and using clean alternative energy has become an important goal of the energy industry. With development of the new energy power generation industry, the energy storage industry, and the new energy automobile industry, as a core energy control apparatus, a converter becomes one of key factors in clean energy application. The converter is an essential unit for transferring renewable energy, that is, solar photovoltaic power, to a power grid.

The converter is configured to: connect an alternating current power supply system and a direct current power supply system, and transfer energy between the two systems. The converter has two working states, that is, rectification and inversion, according to different energy flow directions. Inversion means that energy is transferred from the direct current system to the alternating current system, and rectification means that energy is transferred from the alternating current system to the direct current system.

Generally, the converter includes a switching network, a filter that connects the switching network and an alternating current system, and a control unit connected to the filter.

The switching network of the converter is usually a two-level switching network that can output two levels. The two-level switching network is of a simple structure, but has a relatively great circuit loss and low conversion efficiency. To improve rectification efficiency of the converter, the converter may use a multi-level switching network.

However, with improvement of people's requirement for converter efficiency, due to a circuit loss of a conventional multi-level switching network, converter efficiency is increasingly incapable of meeting the people's requirement. That is, a converter with higher efficiency is expected.

### SUMMARY

Embodiments of this application provide a converter, so that a circuit loss of a switching network can be reduced and converter efficiency can be improved when four or more levels are provided.

According to a first aspect, this application provides a converter, configured to be connected between a direct current system and an alternating current system for mutual conversion between a direct current and an alternating current. The converter includes a switching network, a filter, and a control unit, the switching network includes a first switching circuit and a second switching circuit, the control unit is configured to output a control signal to the switching network, the switching network is configured to convert, into multiple levels according to the control signal that is output by the control unit, a direct current that is output by the direct current system, and the filter is configured to output an alternating current to the alternating current system according to the multiple levels. The first switching circuit includes M energy storage elements and M bridge arm circuits, one of the M bridge arm circuits includes one full-controlled component, remaining M-1 bridge arm circuits each include two full-controlled components that are reversely connected in series, and M is an integer greater than or equal to 1. A first end of an i^{th} bridge arm circuit in the M bridge arm circuits is connected to a first end of an (i+1)^{th} bridge) bridge arm circuit in the M bridge arm circuits by using an i^{th} energy storage element in the M energy storage elements, a first end of an M^{th} bridge arm circuit in the M bridge arm circuits is connected to a first end of the filter by using an M^{th} energy storage element in the M energy storage elements, a second end of each of the M bridge arm circuits is connected to a second end of the filter, and i is an integer that is greater than or equal to 1 and less than M. The second switching circuit includes N energy storage elements and N bridge arm circuits, one of the N bridge arm circuits includes one full-controlled component, remaining N-1 bridge arm circuits each include two full-controlled components that are reversely connected in series, and N is an integer greater than or equal to 4-M. A first end of a j^{th} bridge arm circuit in the N bridge arm circuits is connected to a first end of a (j+1)^{th} bridge arm circuit in the N bridge arm circuits by using a j^{th} energy storage element in the N energy storage elements, a first end of an N^{th} bridge arm circuit in the N bridge arm circuits is connected to the first end of the filter by using an N^{th} energy storage element in the N energy storage elements, a second end of each of the N bridge arm circuits is connected to the second end of the filter, and j is an integer that is greater than or equal to 1 and less than N. Each full-controlled component in the N bridge arm circuits and the M bridge arm circuits is connected to the control unit, and the control unit is specifically configured to control turning-on and turning-off of each full-controlled component.

According to the converter in this embodiment of this application, because the first switching circuit and the second switching circuit in the switching network each include one bridge arm circuit that includes only one full-controlled component, when the converter provides multiple levels, a current in each level state passes through a maximum of two full-controlled components, and currents corresponding to two level states each need to pass through only one full-controlled component. Therefore, a circuit conduction loss can be reduced and circuit efficiency can be improved. In addition, the converter in this embodiment of this application may provide bidirectional circuit energy, that is, the circuit energy may be transferred from a direct current side to an alternating current side, or may be transferred from an alternating current side to a direct current side.

In a possible implementation, the switching network further includes a third switching circuit, the third switching circuit includes two full-controlled components that are reversely connected in series, a first end of the third switching circuit is connected to the first end of the filter, a second end of the third switching circuit is connected to the second end of the filter, each full-controlled component in the third switching circuit is connected to the control unit, and the control unit is configured to control turning-on and turning off of each full-controlled component in the third switching circuit.

In a possible implementation, M is an integer greater than or equal to 2, and M=N.

In a possible implementation, each full-controlled component includes a diode that is reversely connected to the full-controlled component in parallel.

In a possible implementation, the full-controlled component in each bridge arm circuit is reversely connected to a diode in parallel.

In a possible implementation, the energy storage element is a polar capacitor.

In a possible implementation, the first end of the filter is grounded.

In a possible implementation, the filter includes a power inductor and a filter capacitor.

According to a second aspect, this application provides a converter, configured to be connected between a direct current system and an alternating current system for mutual conversion between a direct current and an alternating current. The converter includes a switching network, a filter, and a control unit, the switching network includes three energy storage elements and four bridge arm circuits, the first bridge arm circuit and the fourth bridge arm circuit in the four bridge arm circuits each include one full-controlled component, and the second bridge arm circuit and the third bridge arm circuit in the four bridge arm circuits each include two full-controlled components that are reversely connected in series. A first end of the first bridge arm circuit is connected to a first end of the second bridge arm circuit by using the first energy storage element in the three energy storage elements, the first end of the second bridge arm circuit is connected to a first end of the filter by using the second energy storage element in the three energy storage elements, a first end of the third bridge arm circuit is connected to the first end of the filter, a first end of the fourth bridge arm circuit is connected to the first end of the filter by using the third energy storage element in the three energy storage elements, and second ends of all the four bridge arm circuits are connected to a second end of the filter. Each full-controlled component in the four bridge arm circuits is connected to the control unit, and the control unit is configured to control turning-on and turning-off of each full-controlled component.

According to the converter in this embodiment of this application, because the first switching circuit and the second switching circuit in the switching network each include one bridge arm circuit that includes only one full-controlled component, when the converter provides multiple levels, a current in each level state passes through a maximum of two full-controlled components, and currents corresponding to two level states each need to pass through only one full-controlled component. Therefore, a circuit conduction loss can be reduced and circuit efficiency can be improved. In addition, the converter in this embodiment of this application may provide bidirectional circuit energy, that is, the circuit energy may be transferred from a direct current side to an alternating current side, or may be transferred from an alternating current side to a direct current side.

In a possible implementation, the first end of the filter is grounded.

### BRIEF DESCRIPTION OF DRAWINGS

FIG. 1 is a schematic diagram of an application scenario of a converter according to an embodiment of this application;

FIG. 2 is a schematic circuit diagram of a conventional converter;

FIG. 3 is a schematic circuit diagram of a converter according to an embodiment of this application;

FIG. 4 is a schematic circuit diagram of a converter according to an embodiment of this application;

FIG. 5 is a schematic circuit diagram of a converter according to an embodiment of this application;

FIG. 6 is a schematic circuit diagram of a converter according to an embodiment of this application;

FIG. 7 is a schematic diagram of an output level of a converter according to an embodiment of this application;

FIG. 8 is a schematic circuit diagram of a converter according to an embodiment of this application;

FIG. 9 is a schematic circuit diagram of a converter according to an embodiment of this application; and

FIG. 10 is a schematic circuit diagram of a converter according to an embodiment of this application.

### DESCRIPTION OF EMBODIMENTS

The following further describes in detail technical solutions in embodiments of this application with reference to the accompanying drawings and embodiments.

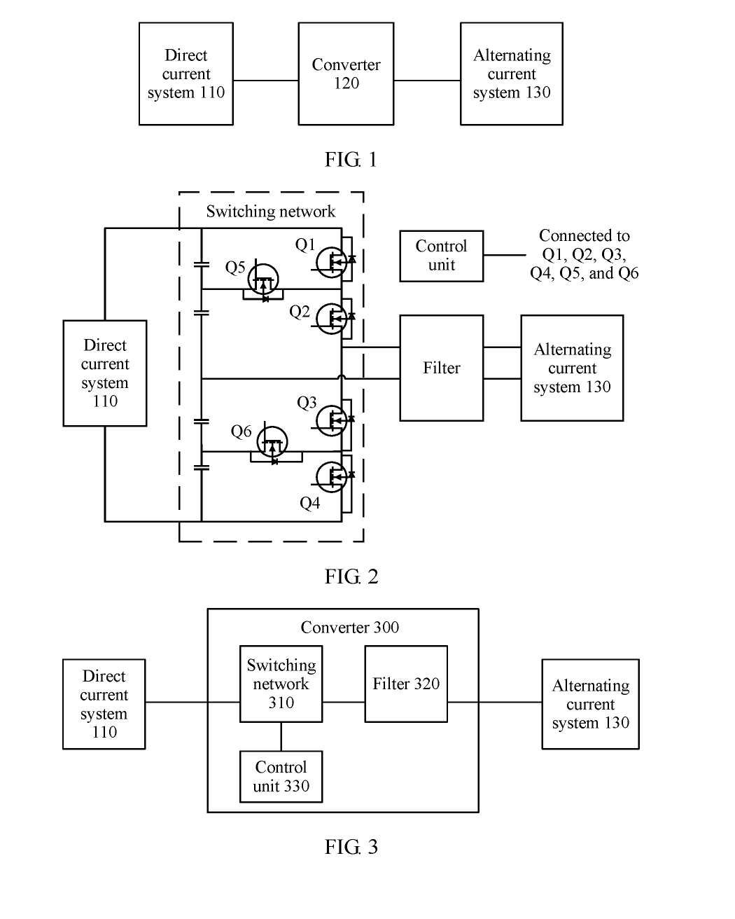

As shown in FIG. 1, a scenario to which a converter in the embodiments of this application can be applied may include a direct current system 110, a converter 120, and an alternating current system 130.

It should be understood that the embodiments of this application are not limited to the application scenario shown in FIG. 1. In addition, the application scenario shown in FIG. 1 is merely an example, and the scenario to which the converter in the embodiments of this application can be applied may further include another system, module, or unit.

In FIG. 1, the direct current system 110 may be any power supply that provides a direct current, and includes a storage battery, a solar photovoltaic panel, and the like. The alternating current system 130 may be any device or apparatus that requires alternating current input, and includes a power grid, a motor, and the like. The converter 120 is configured to: convert, into an alternating current, a direct current provided by the direct current system 110, and output the alternating current to the alternating current system 130; or convert, into a direct current, an alternating current that is output by the alternating current system 130, and output the direct current to the direct current system 110.

For example, in a photovoltaic power supply system, a direct current generated by a solar photovoltaic panel is converted, by using a converter, into an alternating current with same frequency as power grid frequency, and the alternating current is transferred to a power grid (that is, an alternating current unit). Therefore, the photovoltaic power supply system is tied to the power grid.

For another example, a converter in an electric vehicle may work bidirectionally. Specifically, a direct current that is output by a storage battery (that is, a direct current system) of the electric vehicle is converted into an alternating current by using the converter, and the alternating current is output to a motor (that is, an alternating current system). Then, when the electric vehicle decelerates, an inverse alternating current generated by the motor may be converted into a direct current by using the converter, to charge the storage battery.

FIG. 2 is a schematic structural diagram of a conventional converter. In the converter shown in FIG. 2, idle ports of switching transistors Q1, Q2, Q3, Q4, Q5, and Q6 included in a switching network are connected to a control unit of the converter. For brevity, the control unit and a connection relationship between the control unit and the switching transistors are not shown in FIG. 2.

It can be learned from FIG. 2 that, in the switching network of the conventional converter, at any time, a direct current that is output from a direct current system needs to pass through two switching transistors before being converted into an alternating current, so that the alternating current is output to an alternating current system. Specifically, the direct current needs to pass through the switching transistors Q1 and Q2, or needs to pass through the switching transistors Q5 and Q2, or needs to pass through the switching transistors Q6 and Q3, or needs to pass through the switching transistors Q4 and Q3.

Such a structure of the switching network of the conventional converter causes a great circuit conduction loss, and consequently reduces converter efficiency.

Therefore, the embodiments of this application provide a new converter. A switching network of the new converter can reduce a circuit loss, and therefore improve converter efficiency. FIG. 3 is a schematic circuit diagram of a converter according to an embodiment of this application.

As shown in FIG. 3, a converter 300 in this embodiment of this application is connected between a direct current system 110 and an alternating current system 130. The converter 300 may be a three-phase converter.

The converter 300 includes a switching network 310, a filter 320, and a control unit 330. The switching network 310 is connected to the direct current system 110, the filter 320, and the control unit 330. The filter 320 is connected to the alternating current system 120. The control unit 330 may be or may be not connected to the filter 320. This is not limited in this application.

The control unit 330 is configured to output a control signal to the switching network 310. The switching network 310 is configured to convert, into multiple levels according to the control signal that is output by the control unit 330, a direct current that is output by the direct current system 110. The filter 320 is configured to output an alternating current to the alternating current system 120 according to the multiple levels.

If the control unit 330 is connected to the filter 320, the control unit 330 may be specifically configured to output the control signal to the switching network 310 according to an alternating current that is output by the filter, to control the switching network 310 to output the multiple levels.

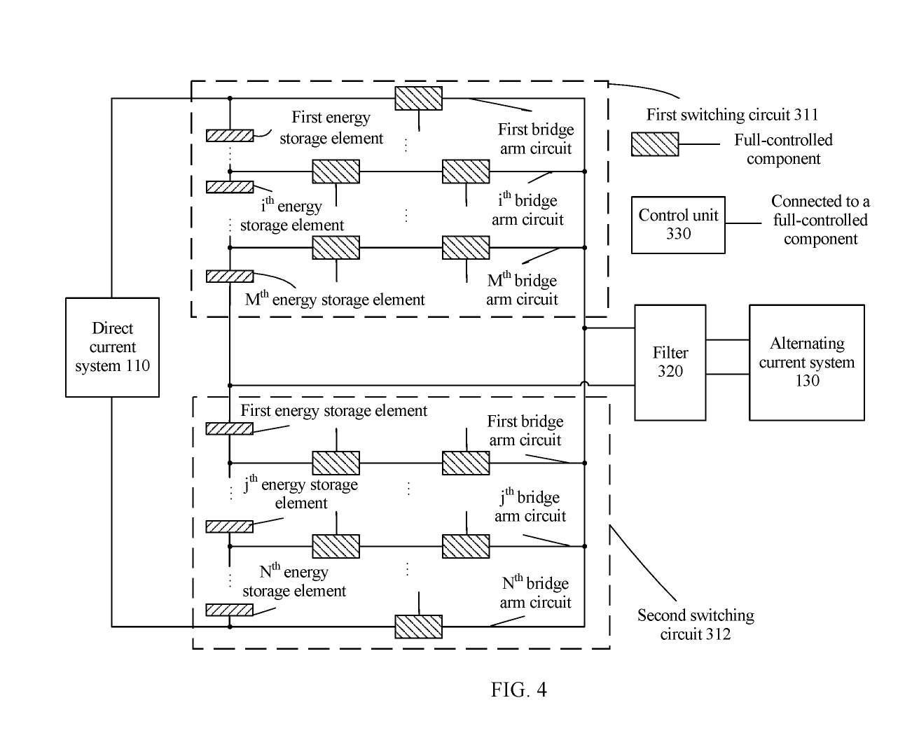

A more detailed schematic circuit diagram of the switching network 310 in this embodiment of this application is shown in FIG. 4. It can be learned from FIG. 4 that, the switching network 310 includes a first switching circuit 311 and a second switching circuit 322.

The first switching circuit 311 includes M energy storage elements (an energy storage element 1 to an energy storage element M) and M bridge arm circuits (a bridge arm circuit 1 to a bridge arm circuit M), and M is an integer greater than or equal to 1.

One of the M bridge arm circuits includes one full-controlled component, and remaining M-1 bridge arm circuits each include two full-controlled components. The two full-controlled components are reversely connected in series. In this embodiment of this application, the full-controlled component may be also referred to as a switching transistor.

That two full-controlled components in a bridge arm circuit are reversely connected in series means that when the two full-controlled components are insulated gate bipolar transistors (Insulate-Gate Bipolar Transistor, IGBT), a collector of a first IGBT is connected to a collector of a second IGBT, or an emitter of a first IGBT is connected to an emitter of a second IGBT; or when the two full-controlled components are metal-oxide-semiconductor field-effect transistors (Metal-Oxide-Semiconductor Field-Effect Transistor, MOSFET), a drain of a first MOSFET is connected to a drain of a second MOSFET, or a source of a first MOSFET is connected to a source of a second MOSFET.

If M is 1, that is, the first switching circuit includes only one bridge arm circuit, the bridge arm circuit includes only one full-controlled component.

A first end of an i^{th} bridge arm circuit in the M bridge arm circuits is connected to a first end of an (i+1)^{th} bridge arm circuit in the M bridge arm circuits by using an i^{th} energy storage element in the M energy storage elements, a first end of an M^{th} bridge arm circuit in the M bridge arm circuits is connected to a first end of the filter by using an M^{th} energy storage element in the M energy storage elements, a second end of each of the M bridge arm circuits is connected to a second end of the filter, and i is an integer that is greater than or equal to 1 and less than M.

That is, one ends of the first bridge arm circuit to the M^{th} bridge arm circuit in the M bridge arm circuits are sequentially connected by using one energy storage element, the one ends of the M^{th} bridge arm circuit and an (M-1)^{th} bridge arm circuit are connected to one end of the filter by using another energy storage element, and the other ends of all the M bridge arm circuits are connected to the other end of the filter.

The second switching circuit includes N energy storage elements and N bridge arm circuits, and N is an integer greater than or equal to 4-M. That is, a sum of a quantity of bridge arm circuits included in the second switching circuit and a quantity of bridge arm circuits included in the first switching circuit needs to be greater than or equal to 4, and a sum of a quantity of energy storage elements included in the second switching circuit and a quantity of energy storage elements included in the first switching circuit needs to be greater than or equal to 4.

Composition and connection relationships of the bridge arm circuits and the energy storage elements in the second switching circuit are similar to those in the first switching circuit. For brevity, details are not described herein again.

One port of each full-controlled component included in the N bridge arm circuits in the second switching circuit and the M bridge arm circuits in the first switching circuit is connected to the control unit 330. The port is configured to receive the control signal that is output by the control unit 330, and then each full-controlled component is turned on or turned off under control of the control signal received by each full-controlled component, so that the full-controlled component can output multiple levels to the filter.

That is, the control unit 330 is configured to output the control signal to each full-controlled component, to control turning-on and turning-off of each full-controlled component, so that the entire switching network 310 can output the multiple levels to the filter according to the direct current received from the direct current system.

The M energy storage elements in the first switching circuit and the N energy storage elements in the second switching circuit are configured to divide a voltage that is output by the direct current system to the switching network.

According to the converter in this embodiment of this application, because the first switching circuit and the second switching circuit in the switching network each include one bridge arm circuit that includes only one full-controlled component, when the converter provides multiple levels, a current in each level state passes through a maximum of two full-controlled components, and currents corresponding to two level states each need to pass through only one full-controlled component. Therefore, a circuit conduction loss can be reduced and circuit efficiency can be improved. In addition, the converter in this embodiment of this application may provide bidirectional circuit energy, that is, the circuit energy may be transferred from a direct current side to an alternating current side, or may be transferred from an alternating current side to a direct current side.

Optionally, a first end of the bridge arm circuit that includes one full-controlled component in the first switching circuit may be connected to a positive electrode of the voltage that is output by the direct current system to the switching network, and a first end of the bridge arm circuit that includes one full-controlled component in the second switching circuit may be connected to a negative electrode of the voltage that is output by the direct current system to the switching network.

Generally, M=N. That is, the quantity of bridge arm circuits and the quantity of energy storage elements in the first switching circuit are respectively equal to the quantity of bridge arm circuits and the quantity of energy storage elements in the second switching circuit, and all the quantities are greater than or equal to 2.

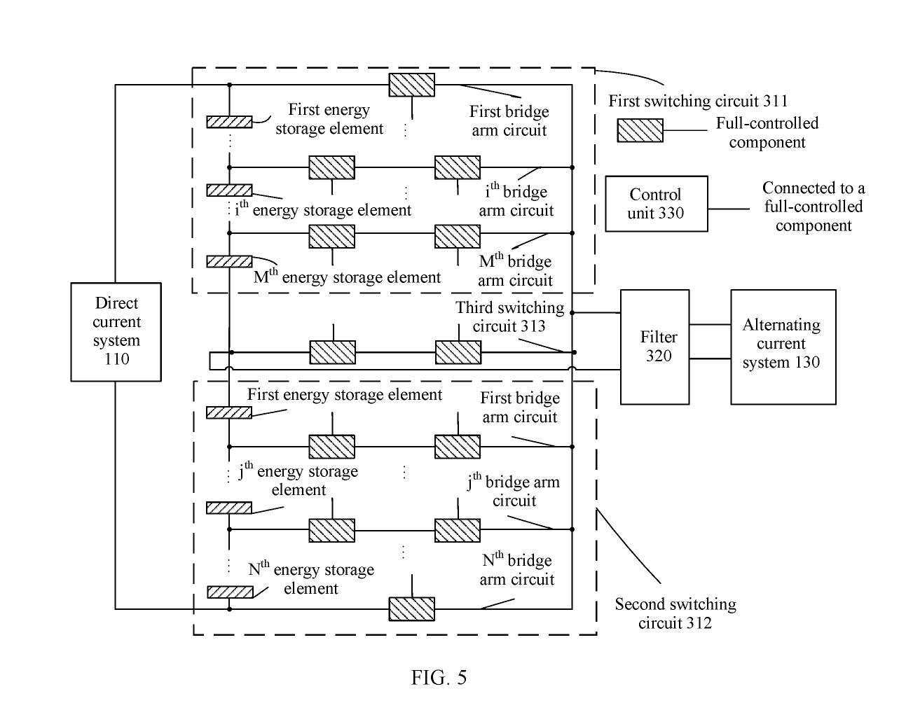

As shown in FIG. 5, optionally, the switching network 310 of the converter in this embodiment of this application may further include a third switching circuit 313. The third switching circuit 313 includes one bridge arm circuit. The bridge arm circuit includes two full-controlled components, and the two full-controlled components are reversely connected in series.

A first end of the third switching circuit is connected to the first end of the filter 320, and a second end of the third switching circuit is connected to the second end of the filter 320.

One port of each full-controlled component in the third switching circuit is connected to the control unit 330. The port is configured to receive the control signal that is output by the control unit 330, and then each full-controlled component is turned on or turned off under control of the control signal received by the full-controlled component, so that the full-controlled component can output multiple levels to the filter together with the full-controlled component in the first switching circuit or the second switching circuit.

That is, the control unit 330 may be further configured to output the control signal to each full-controlled component in the third switching circuit, to control turning-on and turning-off of each full-controlled component, so that the entire switching network 310 can output the multiple levels to the filter according to the direct current received from the direct current system.

The full-controlled component in the switching network in this embodiment of this application may be a component such as a gate turn-off thyristor (Gate Turn-Off Thyristor, GTO), a MOSFET, or an IGBT.

Optionally, the full-controlled component in the switching network in this embodiment of this application may internally include a diode, and the diode is reversely connected in parallel to the full-controlled component to which the diode belongs.

Optionally, each bridge arm circuit in the switching network in this embodiment of this application may further include a diode, and the diode is reversely connected in parallel to a full-controlled component in the bridge arm circuit to which the diode belongs.

That the diode is reversely connected to the full-controlled component in parallel means that when the full-controlled component is an IGBT, a collector of the IGBT is connected to a cathode of the diode, and an emitter of the IGBT is connected to an anode of the diode; or when the full-controlled component is a MOSFET, a drain of the MOSFET is connected to a cathode of the diode, or a source of the MOSFET is connected to an anode of the diode.

Optionally, the energy storage element in the switching network in this embodiment of this application may be a polar capacitor. Certainly, the energy storage element may be an ordinary capacitor (that is, a capacitor regardless of an electrode).

Costs can be reduced when the energy storage element is a polar capacitor rather than an ordinary capacitor. Energy storage efficiency can be improved and an area or a volume of the switching network can be reduced when the energy storage element is an ordinary capacitor rather than a polar capacitor.

In this embodiment of this application, optionally, the end (that is, the first end) that is of the filter and that is connected to the energy storage elements in the bridge arm circuit may be grounded. In other words, the M^{th} energy storage element in the first switching circuit and the N^{th} energy storage element in the second switching circuit may be grounded.

If the energy storage elements in the first switching circuit and the energy storage elements in the second switching circuit are polar capacitors, a negative electrode of an M^{th} polar capacitor in the first switching circuit is grounded, and a positive electrode of an N^{th} polar capacitor in the second switching circuit is grounded.

In this embodiment of this application, optionally, the M^{th} energy storage element in the first switching circuit and the N^{th} energy storage element in the second switching circuit may be connected to a common end in the alternating current system. The common end may be a neutral wire.

In this embodiment of this application, optionally, an example structure of the filter 320 is as follows: The filter 320 may include a power inductor and a filter capacitor. One end of the filter capacitor is connected to one end of the power inductor, the other end of the filter capacitor is connected to the M^{th} energy storage element in the first switching circuit and the N^{th} energy storage element in the second switching circuit, and the other end of the power circuit is connected to the second end of each bridge arm circuit.

In this embodiment of this application, optionally, the converter 300 may further include a unit or a module such as a sampling unit. The sampling unit may be configured to sample a voltage value of each energy storage element. For brevity, details are not described herein.

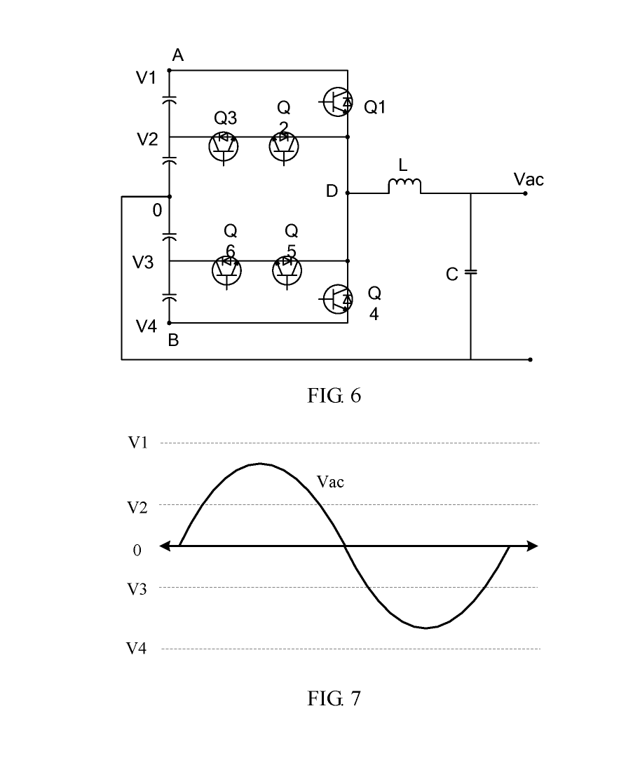

The following describes in detail a circuit structure and a working principle of the converter in this embodiment of this application with reference to FIG. 6. M=2, N=2, an energy storage element is a polar capacitor, a full-controlled component internally includes a diode that is reversely connected to the full-controlled component in parallel, and the filter includes an inductor and a capacitor.

A switching network of a converter shown in FIG. 6 may output four levels, and therefore the switching network may be also referred to as a four-level circuit.

In FIGS. 6, V1, V2, V3, and V4 are respectively sub-voltages, of a voltage output by a direct current system to the switching network, on polar capacitors C1, C2, C3, and C4. The direct current system may be connected to a point A and a point B of the switching network.

Full-controlled components Q1, Q2, Q3, Q4, Q5, and Q6 are connected to a control unit, receive a control signal output by the control unit, and are turned on or turned off under control of the control signal. For brevity of the accompanying drawing, connection lines between the control unit and the full-controlled components Q1, Q2, Q3, Q4, Q5, and Q6 are not drawn in the figure.

The converter shown in FIG. 6 may further include a sampling unit. The sampling unit is configured to sample and obtain V1, V2, V3, V4, and a voltage Vac that is output by the converter to an alternating current system, so that the control unit controls turning-on or turning off of the full-controlled components Q1, Q2, Q3, Q4, Q5, and Q6 according to the foregoing voltage values sampled by the sampling unit, and the switching network can output multiple level values.

Specifically, after the sampling unit obtains V1, V2, V3, and V4, a control switch outputs the control signal to Q1, Q2, Q3, Q4, Q5, and Q6.

If V2≤Vac<V1, the control unit controls Q3 to be steady on and controls Q4 and Q5 to be steady off, and Q6 may be on or may be off In this case, wave transmission logic of Q1 is opposite to wave transmission logic of Q2. A specific implementation in which Q1 and Q2 complement each other in terms of wave transmission is as follows:

It is assumed that a switching period is T, a duty cycle of on time of Q1 is D regardless of impact from dead time of Q1 and Q2. When Q1 is on and Q2 is off, a potential of a point D is equal to V1, and on time of Q1 is D×T. When Q2 is on and Q1 is off, a potential of a point D is equal to V2, and off time of Q1 is (1−D)×T. A voltage of an output end of an inductor L is Vac. Because T is short, Vac may be regarded as a constant value in one period T. It can be learned from an inductor flux volt-second balance principle that D×T×(V1−Vac)+(1−D)×T×(V2−Vac)=0, that is, D=(Vac−V2)/(V1−V2).

When Q1 is on and Q2 is off, there is only one switching transistor Q1 from a direct current side to the point D, and an inductance current may flow in a positive direction, that is, flow from the direct current side and pass through Q1; or may flow in a negative direction, that is, flow to the direct current side and pass through a diode inside Q1. When Q1 is off and Q2 is on, there are two switching transistors Q2 and Q3 from a direct current side to the point D, and an inductance current may flow in a positive direction, that is, flow from the direct current side and pass through diodes inside Q3 and Q2; or may flow in a negative direction, that is, flow to the direct current side and pass through diodes inside Q2 and Q3.

If V3≤Vac<V2, the control unit controls Q2 and Q6 to be steady on and controls Q1 and Q4 to be off, and Q3 and Q5 complement each other in terms of wave transmission. A specific implementation in which Q3 and Q5 complement each other in terms of wave transmission is as follows:

When Q3 is on and Q5 is off, a potential of a point D is equal to V2. Assuming that a duty cycle of Q3 is D regardless of impact from dead time of Q3 and Q5, on time of Q3 is D×T. When Q5 is on and Q3 is off, a potential of a point D is equal to V3, and off time of Q3 is (1−D)×T. A voltage of an output end of an inductor L is Vac. Because T is short, Vac may be regarded as a constant value in one period T. It can be learned from an inductor flux volt-second balance principle that D×T×(V2−Vac)+(1−D)×T×(V3−Vac)=0, that is, D=(Vac−V3)/(V2−V3).

When Q3 is on and Q5 is off, there are two switching transistors Q3 and Q2 from a direct current side to the point D, and an inductance current may flow in a positive direction, that is, flow from the direct current side and pass through diodes inside Q3 and Q2; or may flow in a negative direction, that is, flow to the direct current side and pass through diodes inside Q2 and Q3. When Q3 is off and Q5 is on, there are two switching transistors Q5 and Q6 from a direct current side to the point D, and an inductance current may flow in a positive direction, that is, flow from the direct current side and pass through diodes inside Q6 and Q5; or may flow in a negative direction, that is, flow to the direct current side and pass through diodes inside Q5 and Q6.

If V4≤Vac<V3, the control unit controls Q5 to be steady on and controls Q1 and Q3 to be off, Q2 may be on or off, and Q4 and Q6 complement each other in terms of wave transmission. A specific implementation in which Q4 and Q6 complement each other in terms of wave transmission is as follows:

When Q6 is on and Q4 is off, a potential of a point D is equal to V3. Assuming that a duty cycle of Q6 is D regardless of impact from dead time of Q4 and Q6, on time of Q6 is D×T. When Q4 is on and Q6 is off, a potential of a point D is equal to V4, and off time of Q6 is (1−D)×T. A voltage of an output end of an inductor L is Vac. Because T is short, Vac may be regarded as a constant value in one period T. It can be learned from an inductor flux volt-second balance principle that D×T×(V3−Vac)+(1−D)×T×(V4−Vac)=0, that is, D=(Vac−V4)/(V3−V4).

When Q6 is on and Q4 is off, there are two switching transistors Q5 and Q6 from a direct current side to the point D, and an inductance current may flow in a positive direction, that is, flow from the direct current side and pass through diodes inside Q6 and Q5; or may flow in a negative direction, that is, flow to the direct current side and pass through diodes inside Q5 and Q6. When Q6 is off and Q4 is on, there is only one switching transistor Q4 from a direct current to the point D, and an inductance current may flow in a positive direction, that is, flow from the direct current side and pass through a diode inside Q4; or may flow in a negative direction, that is, flow to the direct current side and passes through Q4.

Finally, a schematic diagram of Vac is shown in FIG. 7.

It can be learned from the foregoing content that the converter shown in FIG. 6 in this embodiment of this application may provide four level states, and only Q1 and Q4 need to be respectively passed through in two of the level states. Therefore, a circuit loss is reduced and circuit efficiency is improved.

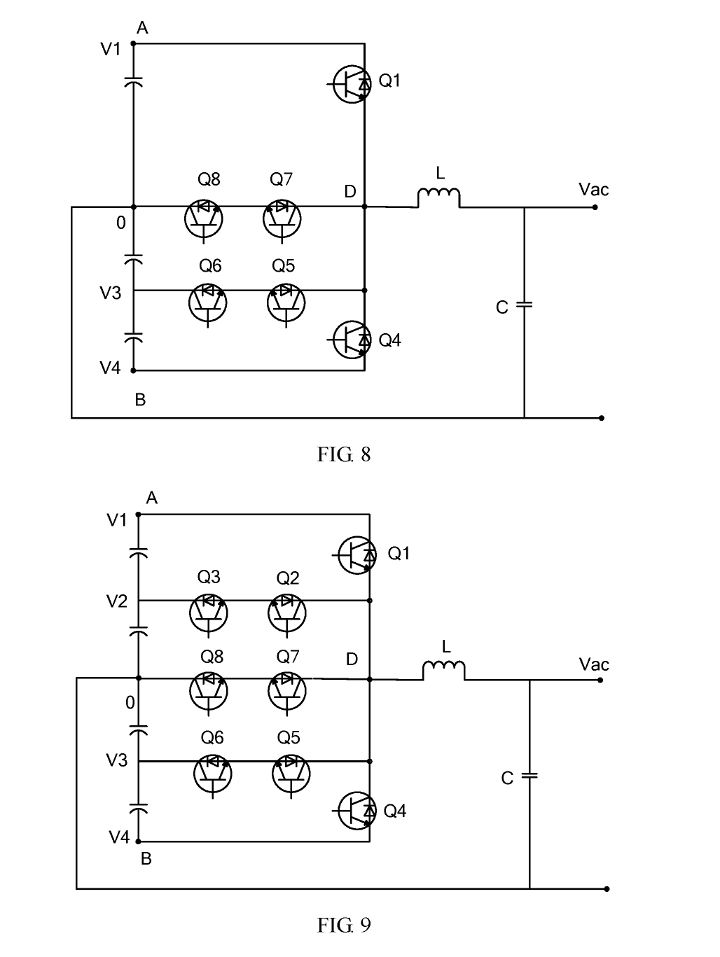

FIG. 8 is a schematic circuit diagram of a converter according to another embodiment of this application. The converter shown in FIG. 8 may provide four level states: V1, 0, V3, and V4.

A first switching circuit in a switching network includes one bridge arm circuit, and the bridge arm circuit includes only one full-controlled component Q1. A second switching circuit in the switching network includes two bridge arm circuits. One bridge arm circuit includes one full-controlled component Q4, and the other bridge arm circuit includes two full-controlled components Q5 and Q6. The switching network further includes a third switching circuit. The third switching circuit includes one bridge arm circuit, and the bridge arm circuit includes two full-controlled components Q7 and Q8.

A working principle of the converter shown in FIG. 8 is similar to a working principle of the converter shown in FIG. 6. For brevity, details are not described herein again.

FIG. 9 is a schematic circuit diagram of a converter according to another embodiment of this application. The converter shown in FIG. 9 may provide five level states: V1, V2, 0, V3, and V4.

A first switching circuit in a switching network includes two bridge arm circuits. One bridge arm circuit includes one full-controlled component Q1, and the other bridge arm circuit includes two full-controlled components Q2 and Q3. A second switching circuit in the switching network includes two bridge arm circuits. One bridge arm circuit includes one full-controlled component Q4, and the other bridge arm circuit includes two full-controlled components Q5 and Q6. The switching network further includes a third switching circuit. The third switching circuit includes one bridge arm circuit, and the bridge arm circuit includes two full-controlled components Q7 and Q8.

A working principle of the converter shown in FIG. 9 is similar to a working principle of the converter shown in FIG. 7. For brevity, details are not described herein again.

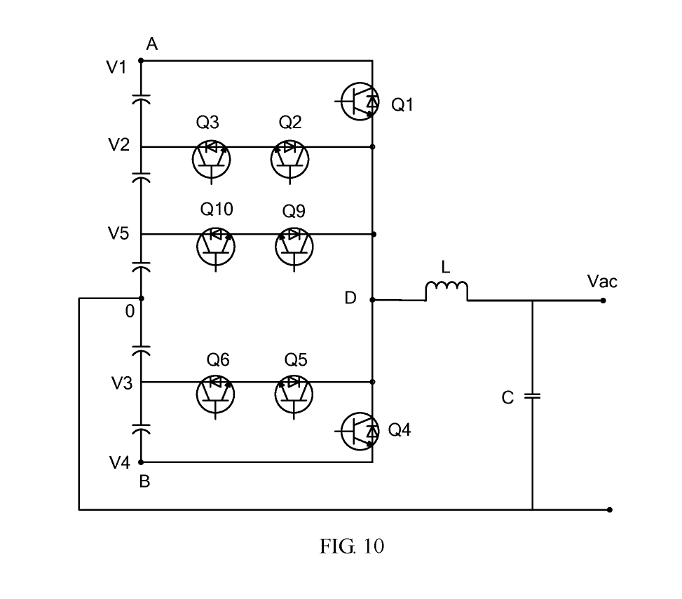

FIG. 10 is a schematic circuit diagram of a converter according to another embodiment of this application. The converter shown in FIG. 10 may provide five level states: V1, V2, V5, V3, and V4.

A first switching circuit in a switching network includes three bridge arm circuits. One bridge arm circuit includes one full-controlled component Q1, another bridge arm circuit includes two full-controlled components Q2 and Q3, and a third bridge arm circuit includes two full-controlled components Q9 and Q10. A second switching circuit in the switching network includes two bridge arm circuits. One bridge arm circuit includes one full-controlled component Q4, and the other bridge arm circuit includes two full-controlled components Q5 and Q6.

A working principle of the converter shown in FIG. 10 is similar to a working principle of the converter shown in FIG. 7. For brevity, details are not described herein again.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A converter, configured to be connected between a direct current system and an alternating current system for mutual conversion between a direct current and an alternating current, wherein the converter comprises a switching network, a filter, and a control unit, the switching network comprises a first switching circuit and a second switching circuit, the control unit is configured to output a control signal to the switching network, the switching network is configured to convert, into multiple-levels voltage according to the control signal that is output by the control unit, a direct current that is output by the direct current system, and the filter is configured to output an alternating current to the alternating current system according to the multiple levels;
the first switching circuit comprises M energy storage elements and M bridge arm circuits, one of the M bridge arm circuits comprises one full-controlled component, remaining M-1 bridge arm circuits each comprise two full-controlled components that are reversely connected in series, and M is an integer greater than or equal to 1;
a first end of an i^{th} bridge arm circuit in the M bridge arm circuits is connected to a first end of an (i+1)^{th} bridge arm circuit in the M bridge arm circuits by using an i^{th} energy storage element in the M energy storage elements, a first end of an M^{th} bridge arm circuit in the M bridge arm circuits is connected to a first end of the filter by using an M^{th} energy storage element in the M energy storage elements, a second end of each of the M bridge arm circuits is connected to a second end of the filter, and i is an integer that is greater than or equal to 1 and less than M;
the second switching circuit comprises N energy storage elements and N bridge arm circuits, one of the N bridge arm circuits comprises one full-controlled component, remaining N-1 bridge arm circuits each comprise two full-controlled components that are reversely connected in series, and N is an integer greater than or equal to 4-M;
a first end of a j^{th} bridge arm circuit in the N bridge arm circuits is connected to a first end of a (j+1)^{th} bridge arm circuit in the N bridge arm circuits by using a j^{th} energy storage element in the N energy storage elements, a first end of an N^{th} bridge arm circuit in the N bridge arm circuits is connected to the first end of the filter by using an N^{th} energy storage element in the N energy storage elements, a second end of each of the N bridge arm circuits is connected to the second end of the filter, and j is an integer that is greater than or equal to 1 and less than N; and
each full-controlled component in the N bridge arm circuits and the M bridge arm circuits is connected to the control unit, and the control unit is specifically configured to control turning-on and turning-off of each full-controlled component.

2. The converter according to claim 1, wherein the switching network further comprises a third switching circuit, the third switching circuit comprises two full-controlled components that are reversely connected in series, a first end of the third switching circuit is connected to the first end of the filter, a second end of the third switching circuit is connected to the second end of the filter, each full-controlled component in the third switching circuit is connected to the control unit, and the control unit is configured to control turning-on and turning-off of each full-controlled component in the third switching circuit.

3. The converter according to claim 1, wherein M is an integer greater than or equal to 2, and M=N.

4. The converter according to claim 1, wherein each full-controlled component comprises a diode that is reversely connected to the full-controlled component in parallel.

5. The converter according to claim 1, wherein the full-controlled component in each bridge arm circuit is reversely connected to a diode in parallel.

6. The converter according to claim 1, wherein the energy storage element is a polar capacitor.

7. The converter according to claim 1, wherein the first end of the filter is grounded.

8. The converter according to claim 1, wherein the filter comprises a power inductor and a filter capacitor.

9. A converter, configured to be connected between a direct current system and an alternating current system for mutual conversion between a direct current and an alternating current, wherein the converter comprises a switching network, a filter, and a control unit, the switching network comprises three energy storage elements and four bridge arm circuits, the first bridge arm circuit and the fourth bridge arm circuit in the four bridge arm circuits each comprise one full-controlled component, and the second bridge arm circuit and the third bridge arm circuit in the four bridge arm circuits each comprise two full-controlled components that are reversely connected in series;
a first end of the first bridge arm circuit is connected to a first end of the second bridge arm circuit by using the first energy storage element in the three energy storage elements, the first end of the second bridge arm circuit is connected to a first end of the filter by using the second energy storage element in the three energy storage elements, a first end of the third bridge arm circuit is connected to the first end of the filter, a first end of the fourth bridge arm circuit is connected to the first end of the filter by using the third energy storage element in the three energy storage elements, and second ends of all the four bridge arm circuits are connected to a second end of the filter; and
each full-controlled component in the four bridge arm circuits is connected to the control unit, and the control unit is configured to control turning-on and turning-off of each full-controlled component.

10. The converter according to claim 9, wherein the first end of the filter is grounded.
